(19) United States
(12) Patent Application Publication
(10) Pub. No.: US 2025/0100459 A1
(43) Pub. Date: Mar. 27, 2025

(54) SENSOR MOUNTING ARRANGEMENT FOR A VEHICLE

(71) Applicant: International Truck Intellectual Property Company, LLC, Lisle, IL (US)

(72) Inventor: Robert M. Tourville, Aurora, IL (US)

(73) Assignee: International Truck Intellectual Property Company, LLC, Lisle, IL (US)

(21) Appl. No.: 18/371,264

(22) Filed: Sep. 21, 2023

(51) Int. Cl. B60R 11/00

(52) U.S. Cl. CPC B60R 11/00; B60R 2011/004; B60R 2011/0045

(57) ABSTRACT

A sensor mounting arrangement for a vehicle includes a vehicle body having a structural pillar disposed adjacent to a vehicle windshield, wherein one or more first sensors is supported by the structural pillar.

### FIELD OF THE INVENTION

The present disclosure relates generally to a sensor mounting arrangement for a vehicle, and more particularly to an arrangement wherein sensors are mounted in existing structural components of a vehicle rather than in structures added specifically to support the sensors.

### BACKGROUND

Sensors are being disposed on surfaces of modern vehicles in ever increasing numbers. Such sensors are distributed all around a vehicle for collecting data from the vehicle surroundings in all directions during vehicle operation for use in critical tasks, for example, including autonomous driving modes. The current industry trend is to add structures to vehicle cabs specifically to support the large number of additionally required sensors. For example, the sensors are added to extensions from the vehicle body surface, which can result in an odd and/or cluttered look, and can add undesirable aerodynamic drag to the profile of the vehicle. Additional body extensions can also add complexity and cost to manufacture. A need therefore exists for a sensor mounting arrangement that utilizes existing structural components without having to add sensor supporting structures or increasing aerodynamic drag.

### SUMMARY OF THE INVENTION

In one aspect of the invention, a sensor mounting arrangement for a vehicle comprises a vehicle body having a structural pillar disposed adjacent to a vehicle windshield, wherein one or more first sensors is supported by the structural pillar.

In another aspect of the invention, a sensor mounting arrangement for a vehicle comprises a vehicle body having a structural pillar disposed adjacent to a vehicle windshield, wherein a plurality of first sensors each having a field of view is supported by the structural pillar, and wherein each of the one or more first sensors is mounted in a protrusion extending outwardly from an exterior surface of the structural pillar.

In a further aspect of the invention, a sensor mounting arrangement for a vehicle comprises a vehicle body having a structural pillar disposed adjacent to a vehicle windshield, and one or more sensor supporting members extending from the vehicle body, wherein each of the one or more sensor supporting members has a leading surface extending away from a forward direction of travel of the vehicle. One or more first sensors each having a field of view is supported by the structural pillar, and one or more second sensors each having a field of view is supported by each of the one or more sensor supporting members.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope.

FIG. 1A is a schematic diagram of an exemplary vehicle body according to an embodiment;

FIG. 1B is a schematic top view of an exemplary sensor supporting member according to an embodiment;

FIG. 2 is a schematic front elevational view of an exemplary windshield and structural pillars according to an embodiment;

FIG. 3A is a schematic side view of a structural pillar according to an embodiment taken generally along the block arrow 3,4 in FIG. 2;

FIG. 3B is a schematic side view of a structural pillar according to another embodiment taken generally along the block arrow 3,4 in FIG. 2;

FIG. 4 is a schematic side view of a structural pillar according to a further embodiment taken generally along the block arrow 3,4 in FIG. 2;

FIG. 5A is a schematic top view of a sensor supporting member according to an embodiment;

FIG. 5B is a schematic top view of a sensor supporting member according to another embodiment; and

FIG. 5C is a schematic top view of a sensor supporting member according to a further embodiment.

In the following detailed description, various embodiments are described with reference to the appended drawings. The skilled person will understand that the accompanying drawings are schematic and simplified for clarity. Like reference numerals refer to like elements or components throughout. Like elements or components will therefore not necessarily be described in detail with respect to each figure.

### DETAILED DESCRIPTION

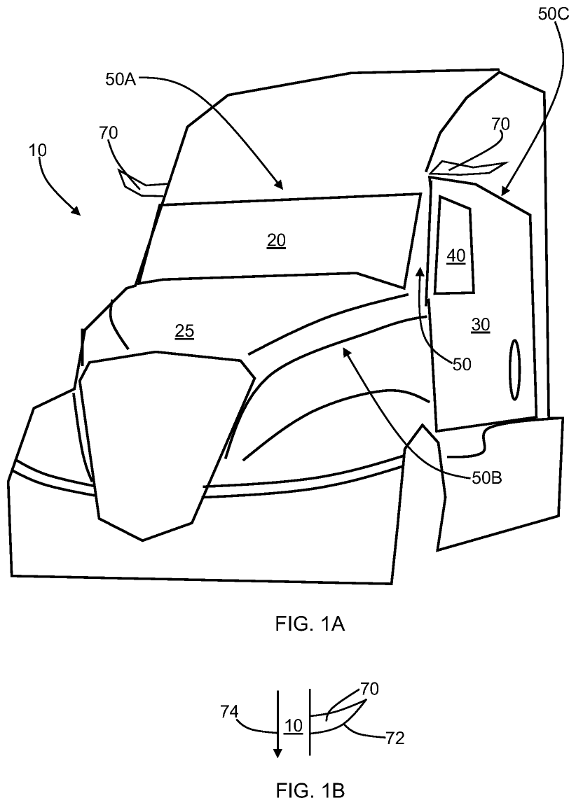

Referring to FIG. 1A, in an embodiment an exemplary vehicle body 10, for example a tractor cab 10, is illustrated having a windshield 20, an engine compartment hood 25, a door 30, and a door window 40. In an embodiment a structural pillar 50 is disposed adjacent to and between the vehicle windshield 20 and the door 30. As illustrated, the vehicle body 10 is viewed in a front and slightly left side view so that the forward direction of travel would be in the direction that the front of the vehicle is facing, which is out of the page and slightly to the left relative to the reader.

Referring to FIG. 2, in an embodiment the exemplary windshield 20 is shown in a front elevational view having a structural pillar 50 disposed on each side of the windshield 20. In an embodiment one or more first sensors 60 is supported by the structural pillar 50.

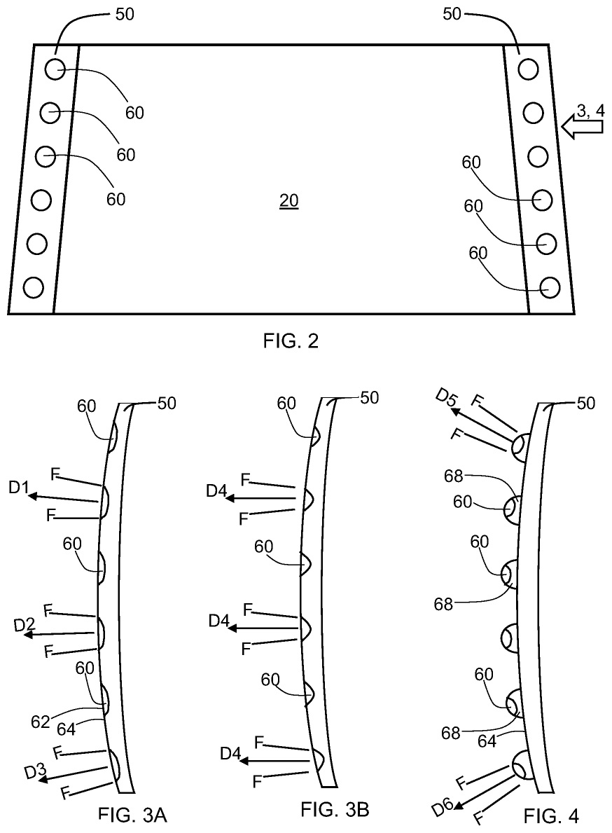

Referring to FIGS. 3A, 3B, and 4, one of the pillars 50 in an embodiment is illustrated as viewed along the block arrow labeled 3, 4 in FIG. 2. In an embodiment the one or more first sensors 60 comprises a plurality of first sensors 60 as shown, each having a field of view, F, bounded by the lines F and facing in a direction, for example, D1, D2, D3, D4, D5, D6, etc. It should be noted that the field of view, F, although shown in two dimensions on FIGS. 3A-5C are actually three-dimensional, extending into and out of the plane of the paper to have a roughly cylindrical or frustoconical shape that extends from each first or second sensor 60, 80. In an embodiment the field of view, F, of each of the plurality of first sensors 60 is facing a common direction, for example, D4 as illustrated in FIG. 3B. In an embodiment, as illustrated in FIG. 3A, the field of view, F, of at least one of the plurality of first sensors 60 is facing in a direction, for example D1, that is different than the directions D2, D3 of the fields of view, F, of other than the at least one of the plurality of first sensors 60. In an embodiment the fields of view, F, of all of the plurality of first sensors 60 are facing in different directions (See FIG. 3A).

In an embodiment as shown in FIG. 3A, a surface 62 disposed across the field of view, F, of each of the one or more first sensors 60 is flush with an exterior surface 64 of the structural pillar 50. Without being held to theory it is believed that by making these meeting surfaces flush that the aerodynamic drag of the pillar 50 is effectively no different than for a similar pillar 50 entirely lacking the first sensors 60; thus, the addition of the first sensors 60 does not add to the aerodynamic drag of the pillar 50 or to the aerodynamic drag of the vehicle body 10.

In an embodiment as shown in FIG. 4, each of the one or more first sensors 60 is mounted in a protrusion 68 extending outwardly from the exterior surface 64 of the structural pillar 50. In this embodiment, due to the geometry of the protrusions 68 extending away from the surface 64, each of the sensors 60 has a greater range of possible facing directions, illustrated for example by D5 and D6, for the sensor field of view, F. Again, without being held to theory it is believed that this greater range of directional selection and control for the sensors 60 can be achieved without a substantial increase in the aerodynamic drag of the pillar 50 by extending the protrusions away from the pillar 50 in the direction of forward travel 74 (see FIG. 1A and below) of the vehicle body 10, thereby not adding to the form drag (caused by the extent of a cross-sectional presence); thus, the addition of the first sensors 60 in protrusions 68 does not significantly add to the aerodynamic drag of the pillar 50 or to the vehicle body 10.

Referring again briefly to FIG. 1A, in an embodiment the vehicle body further comprises one or more sensor supporting members 70, which may be alternatively referred to as winglets 70, extending from the vehicle body 50. Many existing vehicle types have a form of the winglets 70, for example for mounting of running or status lights. FIG. 1B illustrates a top view of the portion of the vehicle body 10 from where the one or more sensor supporting members 70 extends, and indicates a forward direction of travel of the vehicle body 10 by the arrow labeled 74. In an embodiment, each of the one or more sensor supporting members 70 has a leading surface 72 extending away from the forward direction of travel 74 of the vehicle body 10. In an embodiment one or more second sensors 80 is supported by each of the one or more sensor supporting members 70. Without being held to theory, the shape of the leading surface 72 is believed to minimize the added aerodynamic drag resulting from the sensor supporting member 70.

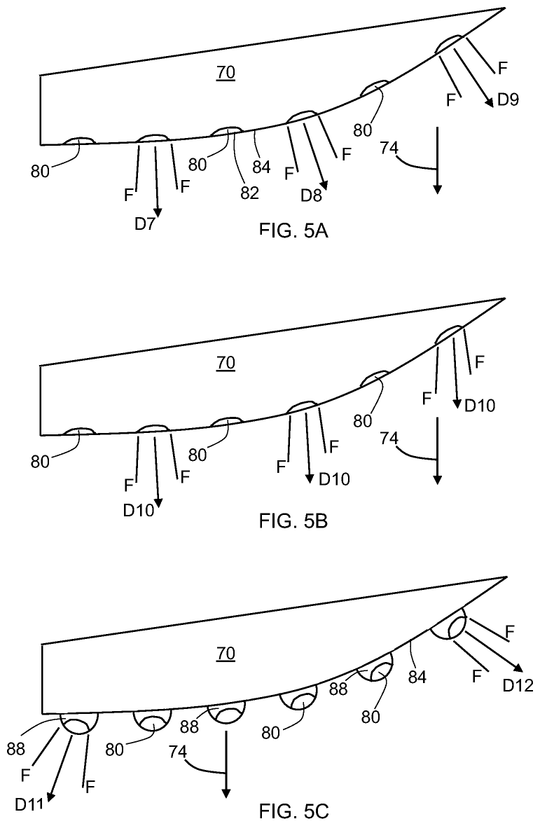

Referring to FIGS. 5A-5C, an exemplary sensor supporting member 70 in an embodiment is illustrated as viewed from above like in FIG. 1A. In an embodiment the one or more second sensors 80 comprises a plurality of second sensors 80 as shown, each having a field of view, F, bounded by the lines F and facing in a direction, for example, D7, D8, D9, D10, D11, D12, etc. In an embodiment the field of view, F, of each of the plurality of second sensors 80 is facing a common direction, for example, D10 as illustrated in FIG. 5B. In an embodiment, as illustrated in FIG. 5A, the field of view, F, of at least one of the plurality of second sensors 80 is facing in a direction, for example D7, that is different than the directions D8, D9 of the fields of view, F, of other than the at least one of the plurality of second sensors 80. In an embodiment the fields of view, F, of all of the plurality of second sensors 80 are facing in different directions (See FIG. 5A).

In an embodiment as shown in FIG. 5A, a surface 82 disposed across the field of view, F, of each of the one or more second sensors 80 is flush with an exterior surface 84 of the sensor supporting member 70. Without being held to theory it is believed that by making these meeting surfaces flush that the aerodynamic drag of the sensor supporting member 70 is effectively no different than for a similar sensor supporting member 70 entirely lacking the second sensors 80; thus, the addition of the second sensors 80 does not add to the aerodynamic drag of the sensor supporting member (or winglet) 70 or to the aerodynamic drag of the vehicle body 10.

In an embodiment as shown in FIG. 5C, each of the one or more second sensors 80 is mounted in a protrusion 88 extending outwardly from the exterior surface 84 of the sensor supporting member 70. In this embodiment, due to the geometry of the protrusions 88 extending away from the surface 84, each of the sensors 80 has a greater range of possible facing directions, illustrated for example by D11 and D12, for the sensor field of view, F. Again, without being held to theory it is believed that this greater range of directional selection and control for the sensors 80 can be achieved without a substantial increase in the aerodynamic drag of the sensor supporting member 70 by extending the protrusions 88 away from the sensor supporting member 70 in the direction of forward travel 74 of the vehicle body 10, thereby not adding to the form drag; thus, the addition of the second sensors 80 in protrusions 88 does not significantly add to the aerodynamic drag of the sensor supporting member (or winglet) 70 or to the aerodynamic drag of the vehicle body 10.

In an embodiment the directions that each of the first and second sensors 60, 80 faces is determined by how each sensor 60, 80 is positioned within the pillar 60 or the sensor supporting member 70 at the time of manufacture. In another embodiment, the direction that each of the sensors 60, 80 faces is not fixed but can rather be adjusted during operation by an actuator (not shown) upon which the first sensor 60 is mounted within the pillar 50, or upon which the second sensor 80 is mounted within the sensor supporting member 70.

In an embodiment each of the one or more first sensors 60 and each of the one or more second sensors 80 can be the same as or different from all the other first and second sensors 60, 80. The differences can be in terms of size, geometry, power draw, and type of sensor, among other differences. In an embodiment each of the one or more first sensors 60 and each of the one or more second sensors 80 is selected from the group of sensors consisting of an optical sensor, a light direction and ranging (LIDAR) sensor, a radio detection and ranging (RADAR) sensor, an infrared sensor, and a sonic sensor.

Referring again to FIG. 1, in other embodiments, the structural pillar 50 is identified at other portions of the vehicle body 10, for example without limitation, as a portion 50A of the body 10 just above the windshield 20, or as a portion 50B of the body 10 on a side of the engine compartment hood 25, or as a portion 50C of the body 10 on a side of the body 10 just above the door 30. In all of the embodiments disclosed hereinabove, any description of structure or function in relation to the structural pillar 50 also applies equally to the structural pillars 50A, 50B, or 50C. For example, any of the structural pillars 50A, 50B, or 50C could have one or more first or second sensors 60, 80 supported thereby, where the one or more sensors 60, 80 are flush with a surface of the structural pillars 50A, 50B, or 50C (like the structures illustrated in FIGS. 3A and 5A), or where the one or more sensors 60, 80 are mounted in a protrusion extending outwardly from an exterior surface of the structural pillars 50A, 50B, or 50C (like the structures illustrated in FIGS. 4 and 5C).

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity. Unless otherwise noted, the use of the words “approximate,” “about,” “around,” “substantially,” etc., mean plus or minus ten percent.

### INDUSTRIAL APPLICABILITY

A sensor mounting arrangement includes sensors mounted within structural elements of a vehicle body. The arrangement provides a way to mount a large number of sensors on the vehicle body without the undesirable addition of externally extending members that are unsightly, expensive to produce and add to the aerodynamic drag of the vehicle body. The sensor mounting arrangement can be manufactured in industry for use on vehicles purchased by consumers.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

I claim:

1. A sensor mounting arrangement for a vehicle, comprising:
a vehicle body having a structural pillar disposed adjacent to a vehicle windshield;
wherein one or more first sensors is supported by the structural pillar.

2. The sensor mounting arrangement of claim 1, wherein the one or more first sensors comprises a plurality of first sensors each having a field of view.

3. The sensor mounting arrangement of claim 2, wherein the field of view of each of the plurality of first sensors is facing a common direction.

4. The sensor mounting arrangement of claim 2, wherein the field of view of at least one of the plurality of first sensors is facing in a direction that is different than directions of the fields of view of other than the at least one of the plurality of first sensors.

5. The sensor mounting arrangement of claim 1, wherein a surface disposed across the field of view of each of the one or more first sensors is flush with an exterior surface of the structural pillar.

6. The sensor mounting arrangement of claim 1, wherein each of the one or more first sensors is mounted in a protrusion extending outwardly from an exterior surface of the structural pillar.

7. The sensor mounting arrangement of claim 1, further comprising one or more sensor supporting members extending from the vehicle body, wherein each of the one or more sensor supporting members has a leading surface extending away from a forward direction of travel of the vehicle, and wherein one or more second sensors are supported by each of the one or more sensor supporting members.

8. The sensor mounting structure of claim 7, wherein each of the one or more first sensors and each of the one or more second sensors is selected from the group of sensors consisting of an optical sensor, a light direction and ranging (LIDAR) sensor, a radio detection and ranging (RADAR) sensor, an infrared sensor, and a sonic sensor.

9. A sensor mounting arrangement for a vehicle, comprising:
a vehicle body having a structural pillar disposed adjacent to a vehicle windshield;
wherein a plurality of first sensors each having a field of view is supported by the structural pillar;
wherein each of the one or more first sensors is mounted in a protrusion extending outwardly from an exterior surface of the structural pillar.

10. The sensor mounting arrangement of claim 9, wherein the field of view of each of the plurality of first sensors is facing a common direction.

11. The sensor mounting arrangement of claim 9, wherein the field of view of at least one of the plurality of first sensors is facing in a direction that is different than directions of the fields of view of other than the at least one of the plurality of first sensors.

12. The sensor mounting arrangement of claim 9, further comprising one or more sensor supporting members extending from the vehicle body, wherein each of the one or more sensor supporting members has a leading surface extending away from a forward direction of travel of the vehicle, and wherein one or more second sensors are supported by each of the one or more sensor supporting members.

13. The sensor mounting arrangement of claim 12, wherein each of the plurality of first sensors and each of the one or more second sensors is selected from the group of sensors consisting of an optical sensor, a light direction and ranging (LIDAR) sensor, a radio detection and ranging (RADAR) sensor, an infrared sensor, and a sonic sensor.

14. A sensor mounting arrangement for a vehicle, comprising:
a vehicle body having a structural pillar disposed adjacent to a vehicle windshield;
one or more sensor supporting members extending from the vehicle body, wherein each of the one or more sensor supporting members has a leading surface extending away from a forward direction of travel of the vehicle,
wherein one or more first sensors each having a field of view is supported by the structural pillar; and
wherein one or more second sensors each having a field of view is supported by each of the one or more sensor supporting members.

15. The sensor mounting arrangement of claim 14, wherein the field of view of at least one of the one or more first sensors or of at least one of the one or more second sensors is facing in a direction that is different than directions of the fields of view of other than the at least one of the one or more first sensors or of at least one of the one or more second sensors.

16. The sensor mounting arrangement of claim 14, wherein each of the one or more first sensors is mounted in a protrusion extending outwardly from an exterior surface of the structural pillar.

17. The sensor mounting arrangement of claim 14, wherein a surface disposed across the field of view of each of the one or more first sensors is flush with an exterior surface of the structural pillar.

18. The sensor mounting arrangement of claim 14, wherein each of the one or more second sensors is mounted in a protrusion extending outwardly from the leading surface.

19. The sensor mounting arrangement of claim 14, wherein a surface disposed across the field of view of each of the one or more second sensors is flush with the leading surface.

20. The sensor mounting arrangement of claim 14, wherein each of the one or more first sensors and each of the one or more second sensors is selected from the group of sensors consisting of an optical sensor, a light direction and ranging (LIDAR) sensor, a radio detection and ranging (RADAR) sensor, an infrared sensor, and a sonic sensor.
